(19) United States
(12) Patent Application Publication
(10) Pub. No.: US 2003/0179061 A1
(43) Pub. Date: Sep. 25, 2003

(54) Casing of a flyback transformer

(76) Inventors: Ching Hsiang Wang, Tao Yuan Hsien (TW); Reiy Long Wang, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/100,068

(22) Filed: Mar. 19, 2002

(51) Int. Cl. H01F 27/06

(52) U.S. Cl. 336/65

(57) ABSTRACT

A minimized casing structure of a flyback transformer includes a base, a chamber, a guiding tube, and a rod. The chamber is formed on a side of the top surface of the base, while a recess is formed on the other side. A first extension platform is formed at front side of the base, and between the first extension platform and the front side of the base a plurality of enhancement ribs are provided. The first extension platform is connected with a second extension platform, wherein the rod is formed on the second extension platform extending from a bottom face of the second extension platform, and at least one enhancement rib is formed between the rod and the bottom face of the second extension platform.

### BACKGROUND OF THE INVENTION

1. Field of the Invention

The present invention relates to the field of flyback transformers, and more particularly, to a cost-effective flyback transformer having a minimized and solid casing structure.

2. Description of the Prior Art

A flyback transformer is generally implemented within the circuits of a display device for providing distinctive voltages required by the circuit operation of the display device. Due to the trend toward smaller or thinner electrical apparatuses, the dimension of the flyback transformer is limited. One approach of lowering the production cost of the electrical apparatus is reducing the size of the casing of the flyback transformer.

Please refer to FIG. 1 and FIG. 2. FIG. 1 is a perspective diagram depicting a conventional casing structure of a flyback transformer (FBT). FIG. 2 is a side view of FIG. 1. The casing 1 generally comprises a base 10 and a chamber 11, a guiding tube 111, and a rod 121. The chamber 11, which is used to landing a low voltage bobbin and a high voltage bobbin, is typically located on a top surface of the base 10 (not explicitly shown in FIG. 1 and FIG. 2). The guiding tube 111 axially extends from a front side of the chamber 11. An opening 112 is formed at the rear portion near a side of the chamber 11. An extension pole 12 is formed on a front end of the base 10. On the free end of the extension pole 12 is formed a rod 121.

Still referring to FIG. 2. The chamber 11 is located on one side of the base 10 of the casing 1. Assuming that the casing 1 is divided into an upper portion and a lower portion by the guiding tube 111, and as shown in FIG. 2, the height of the chamber 11 is corresponding to the height of the base 10, the chamber 11 is also divided into two portions: an upper portion and a lower portion. It is well known that the upper portion of the chamber 11 is used to accommodate the high/low voltage bobbins.

However, the prior art casing 1 structure is not minimized. The bigger casing does not obey the current trend of size shrinking. Further, the shrunk casing structure encounters a problem of insufficient mechanical strength. Consequently, there is a need to provide a minimized and solid flyback transformer casing to reduce production cost.

### SUMMARY OF THE INVENTION

It is therefore a primary object of the present invention to provide a casing structure of a flyback transformer that is small in size while without affecting the mechanical strength of the casing.

It is another objective of this invention to provide an improved low voltage bobbin for flyback transformers having mechanically strengthened slender wire winding rods.

According to the claimed invention, a minimized casing structure of a flyback transformer includes a base, a chamber, a guiding tube, a recess and a rod.

The base has formed at the front side thereof a first extension platform, and a plurality of enhancement ribs between the first extension platform and the front side of the base, and a second extension platform is connected with the front side of the first extension platform. The chamber is formed on a side of the top surface of the base. The guiding tube axially extends from a front side of the chamber, and the recess is formed on the other side of the base, and the rod is formed on the second extension platform and extends from a bottom face of the second extension platform, wherein at least one enhancement rib is formed between the rod and the bottom face of the second extension platform.

In another embodiment, the second extension platform has a plurality of enhancement ribs on its top surface. The enhancement ribs are formed between the top surface of the base and a side of the chamber next to the recess.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a perspective diagram depicting a conventional casing structure of a flyback transformer.

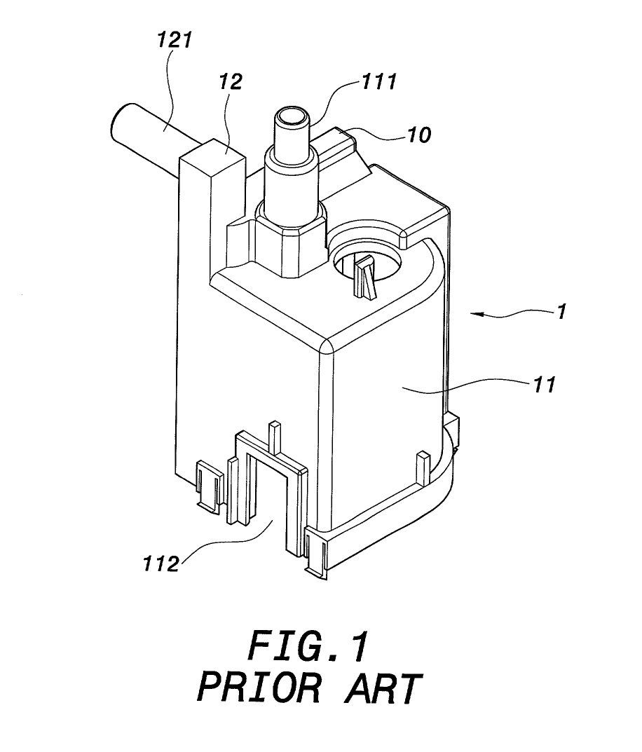

FIG. 2 is a side view of FIG. 1.

FIG. 3 is a perspective diagram depicting a casing structure of a flyback transformer according to this invention.

FIG. 4 is a side view of FIG. 3.

### DETAILED DESCRIPTION OF THE PREFERRED EMBODIMENT

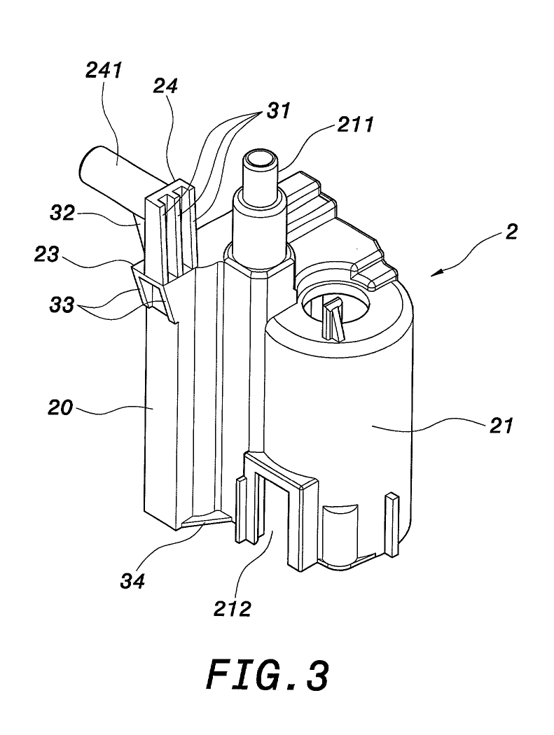

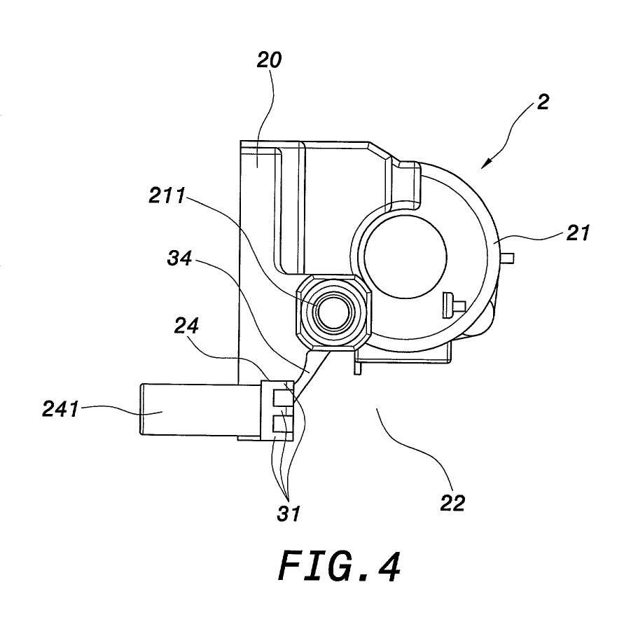

Please refer to FIG. 3 and FIG. 4. FIG. 3 is a perspective diagram depicting a casing structure of a flyback transformer according to one preferred embodiment of this invention. FIG. 4 is a side view of FIG. 4. A flyback transformer generally includes a low voltage bobbin, an iron shaft, a high voltage bobbin, and a casing 2. As shown, the casing 2 comprises a base 20 and a chamber 21, a guiding tube 211, and a rod 241.

Chamber 21 is located on one side of a top surface of the base 20. On the other side of the top surface of the base 20 is provided a recess 22. A side between the chamber 21 and the recess 22 of the base 20 there is provided an opening 212. The guiding tube 211 axially extends from a front side of the chamber 21.

As illustrated, on a front side of the base 20 there is provided a first extension platform 23. Between the first extension platform 23 and the front side of the base 20 a plurality of enhancement ribs 33 are provided.

The first extension platform 23 is connected with a second extension platform 24 in the front end of the first extension platform 23. The rod 241 is formed on the second extension platform extending from a bottom face of a free distal end of the second extension platform 24. An enhancement rib 32 is formed between the rod 241 and the second extension platform 24. Of course, a plurality of enhancement ribs 31 may be formed on the top surface of the second extension platform 24 to increase the mechanical strength of the second extension platform 24.

Between the top surface of the base 20 and the side of the chamber 21 that is next to the recess 22 is provided an enhancement rib 34. Preferably, the enhancement rib 34 is formed at a rear side of the casing 2.

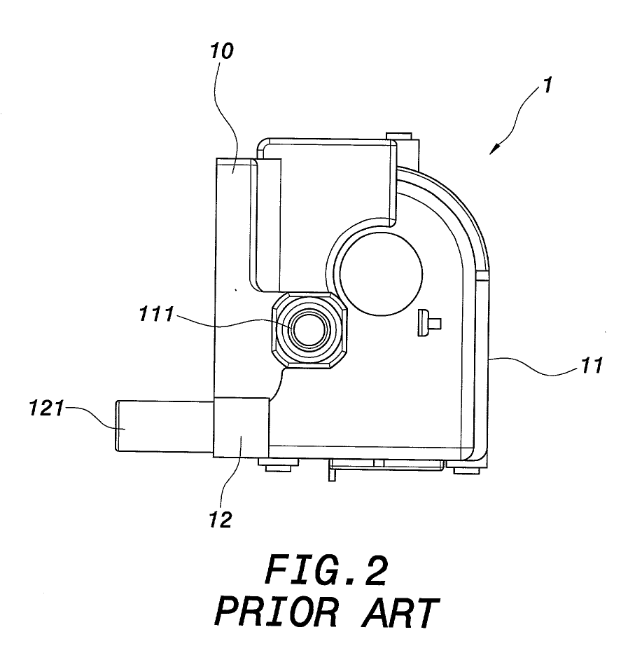

In contrast to the prior art, this invention overcomes the drawbacks of the conventional approach. The prior art casing has a chamber 11 that covers one side of the base (as shown in FIG. 2). The chamber 21 according to this invention is shrunk as illustrated in FIG. 3. The saved space due to the shrinking of the chamber 21 is provided the recess 22 as shown in FIG. 4. From above, this invention has achieved the goal of minimizing the size of casing and thus reducing the cost of the flyback transformer. Further, to remedy the reduced mechanical strength of the base 2 corresponding to the recess 22 due to the shrunk chamber, the enhancement rib 32 is formed between the rod 241 and the bottom face of the second extension platform 24 and the symmetrically arranged first extension rib 33 is formed on the side of the base 20 next to the first extension platform 23. In another embodiment, the second extension platform 24 has three enhancement ribs 31 on its top surface. Or, the enhancement rib 34 may be formed at the rear side of the casing 2 between the chamber 21 and the top surface of the base 20.

In short, it is advantageous to use the present invention since that the minimized structure of the casing is cost-effective and solid.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A minimized casing structure of a flyback transformer comprising:
a base having formed at the front side thereof a first extension platform, a plurality of enhancement ribs between the first extension platform and the front side of the base, and a second extension platform connected with the front side of the first extension platform;
a chamber formed on a side of the top surface of the base;
a guiding tube axially extending from a front side of the chamber;
a recess is formed on the other side of the base; and
a rod formed on the second extension platform and extending from a bottom face of the second extension platform;
wherein at least one enhancement rib is formed between the rod and the bottom face of the second extension platform.

2. The casing structure of claim 1, wherein a plurality of enhancement ribs are formed on top surface of the second extension platform.

3. The casing structure of claim 2, wherein a enhancement rib is formed between the top surface of the base and a side of the chamber next to the recess.

4. The casing structure of claim 3, wherein the enhancement ribs formed between the base and the chamber are located at a rear part of the casing.

5. The casing structure of claim 1, wherein enhancement ribs are formed between the top surface of the base and a side of the chamber next to the recess.

6. The casing structure of claim 5, wherein the enhancement ribs formed between the base and the chamber are located at a rear part of the casing.

7. The casing structure of claim 1, wherein an opening is formed on a side of the chamber next to the recess.
